(19) United States
(12) Patent Application Publication
(10) Pub. No.: US 2008/0182229 A1
(43) Pub. Date: Jul. 31, 2008

(54) METHOD AND SYSTEM FOR LEADING COMPOSITION

(75) Inventors: Seungkea Kwack, Goyang-si (KR); Dae-hyun Kim, Yongin-si (KR); Young nam Kim, Seoul (KR); Jong Hyun Ryu, Seoul (KR); Hyeon Mi Lee, Seoul (KR)

Correspondence Address: MILLER NASH LLP, 601 UNION STREET, SUITE4400, SEATTLE, WA, 98101-2352, US

(73) Assignee: CDI HOLDINGS CO., LTD., Seoul (KR)

(21) Appl. No.: 11/754,247

(22) Filed: May 25, 2007

(30) Foreign Application Priority Data
Jan. 31, 2007 (KR) 10-2007-0010294

(51) Int. Cl. G09B 5/00

(52) U.S. Cl. 434/169; 434/167

(57) ABSTRACT

Disclosed herein is a method and system for leading composition capable of being performed by the leading of an instructor with respect to the composition prepared and submitted by a learner, in which errors are extracted from the composition, so that teaching and learning composition are performed through correction, error remediation, and index study based on the errors.

The method for teaching and learning composition comprises constructing a learning composition database including an index database wherein index information associated with the composition is stored, providing a learning topic to a learner with reference to the leading composition database and receiving correction information associated with the composition prepared by the learner from an instructor, extracting the index information from the index database included in the leading composition database; and providing instruction information including the correction information and the index information to the learner.

### CROSS-REFERENCE TO RELATED APPLICATION

This application claims priority from Korean Patent Application No. 10-2007-0010294, filed on Jan. 31, 2007, in the Korean Intellectual Property Office, the entire disclosure of which is incorporated herein by reference.

### BACKGROUND OF THE INVENTION

1. Field of the Invention

The present invention relates to a method and system for teaching and learning written composition (hereinafter referred to as “leading composition”) performed by the teaching of an instructor with respect to composition prepared and submitted by a person learning to compose (hereinafter referred to as “learner”), and more particularly, to a method and system for leading composition in which errors are extracted from the composition prepared and submitted by the learner, so that leading composition is performed through correction, error remediation, and index study based on errors.

2. Description of Related Art

A conventional method for leading composition is performed in such a manner that a learner prepares composition with respect to a given subject, and an instructor points out the grammatical and logical errors with respect to the composition.

However, in the conventional method for leading composition, the focus is solely concentrated on grammatical knowledge, making the conventional method infeasible or unsuitable for learners to develop real composition ability required for situations such as studying abroad and the like. Also, there is oftentimes no clear objective criteria or definitive guidelines used by instructors for making corrections to compositions of learners, and various corrections are made by applying a subjective criteria of the instructor.

In the conventional method for leading composition, it is difficult for a person learning to compose to figure out which part of the composition needs further improvement and what or how to modify a composition independently. Although instructors carefully provide corrections to learners, it is common for frustrated learners to lose confidence and interest in preparing and learning to compose.

Furthermore, general corrections are typically made by the instructors after the compositions are completed, and a person learning to compose sentences does not learn to modify the composition independently despite the fact that a person recognizes which part of the composition needs work. Therefore, errors previously made by the person learning to compose are repeated in subsequent compositions, and the ability to compose sentence structures is not improved.

There needs to be an interactive system and process of helping people learning to compose to get instant and on-going feedback from instructors while a person is composing and writing.

### SUMMARY OF THE INVENTION

An aspect of the present invention provides a method and system for leading composition, by which a learner prepares and submits a composition to an instructor. After submitting the composition, the first correction information of the instructor based on an index information previously created by analyzing and objectively arranging structural data, is provided to the learner. An opportunity is given for the learner to independently modify errors in the composition from which the following information is provided to the learner: the first correction information, the second correction information from the instructor, an estimation score and a general review with respect to the composition. The second correction information provided is based on an index information previously created by analyzing and objectively arranging data with respect to organization, style, and summary of the composition.

According to another aspect of the present invention, a method for leading composition is provided in which the method comprises: constructing a leading composition database including an index database wherein index information associated with the composition is stored; providing a learning topic to a learner with reference to the leading composition database and receiving correction information associated with the composition prepared by the learner from an instructor; extracting the index information from the index database included in the leading composition database; and providing instruction information including the correction information and the index information to the learner.

According to another aspect of the present invention, a method for leading composition is provided, wherein the method of constructing the leading composition database includes: constructing the index database by storing the index information being leading information provided to the learner; constructing a learning topic database by storing a learning topic to be provided to the learner; constructing a learner database by storing learner information including a learning level of the learner; constructing an instructor database by storing instructor information related to the learning topic; and constructing an evaluation items database by storing evaluation items related to the learning topic.

According to another aspect of the present invention, a method for leading composition is provided, wherein the method of constructing the learning topic database includes: storing the learning topic in association with the learning level of the learner being provided with the learning topic; storing a model answer associated with the learning topic in association with the learning level; and extracting high-order title information from the index database and storing the extracted high-order title information in association with the learning topic.

According to another aspect of the present invention, there is provided a method for leading composition, wherein the method of constructing the learning topic database further includes: storing related information including a notice for composition type, composition schedule, affixed moving picture information, and correction associated with the learning topic, and word information in association with the learning topic.

According to another aspect of the present invention, there is provided a system for leading composition, the system comprising: a leading composition database-constructing component configured to construct a leading composition database by storing leading composition information including an index associated with the composition, a learning topic-providing component configured to provide a learning topic to a learner with reference to the leading composition database, a first composition-receiving component configured to receive first composition prepared associated with the learning topic from the learner, a correction information-receiving component configured to receive correction information associated with the first composition from an instructor after providing the first composition to the instructor, a first instruction information-providing component configured to provide first instruction information to the learner, a second composition-receiving component configured to receive second composition from the learner, a correct answer information-providing component configured to provide correct answer information to the learner, a second instruction information-providing component configured to provide second instruction information to the learner, and an evaluation information-providing component configured to provide evaluation information to the learner.

Furthermore, according to another aspect of the present invention, there is provided a system for leading composition, wherein the leading composition database-constructing component includes: a learning topic database-constructing component configured to construct a leaning topic database by storing the learning topic to be provided to the learner, a learner database-constructing component configured to construct a learner database by storing learner information including a learning level of the learner, an instructor database-constructing component configured to construct an instructor database by storing instructor information associated with the learning topic, an index database-constructing component configured to construct an index database by storing an index being learning information provided to the learner, and an evaluation item database-constructing component configured to construct an evaluation item database by storing the evaluation item.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a schematic view illustrating a method and system for leading composition according to an exemplary embodiment of the present invention;

FIG. 2 is a flowchart illustrating a method for leading composition according to an exemplary embodiment of the present invention;

FIG. 3 is a flowchart illustrating a method for constructing a learning topic database according to an exemplary embodiment of the present invention;

FIG. 4 illustrates a process for constructing a learning topic database in association with high-order title information included in an index according to an exemplary embodiment of the present invention;

FIG. 5 illustrates a structure of an index database according to an exemplary embodiment of the present invention;

FIG. 6 illustrates a process for receiving first composition from a learner according to an exemplary embodiment of the present invention;

FIG. 7 is a flowchart illustrating a process for receiving first correction information from an instructor according to an exemplary embodiment of the present invention;

FIG. 8 illustrates a process for receiving first correction from an instructor according to an exemplary embodiment of the present invention;

FIG. 9 is a flowchart illustrating a process for receiving second correction information from an instructor according to an exemplary embodiment of the present invention;

FIG. 10 illustrates a process for receiving second correction from an instructor according to an exemplary embodiment of the present invention;

FIG. 11 illustrates a process for re-receiving instruction information having been modified by an instructor according to an exemplary embodiment of the present invention;

FIG. 12 illustrates a process for receiving estimation information from an instructor according to an exemplary embodiment of the present invention;

FIG. 13 is a flowchart illustrating a process for providing first instruction information to a learner according to an exemplary embodiment of the present invention;

FIG. 14 illustrates a process for providing first instruction information to a learner according to an exemplary embodiment of the present invention;

FIG. 15 illustrates a process for providing correct answer information to a learner according to an exemplary embodiment of the present invention;

FIG. 16 is a flowchart illustrating a process for providing second correction information to a learner according to an exemplary embodiment of the present invention;

FIG. 17 illustrates a process for providing second correction information to a learner according to an exemplary embodiment of the present invention;

FIG. 18 illustrates a process for providing estimation information to a learner according to an exemplary embodiment of the present invention;

FIG. 19 illustrates a structure of a learning process database according to an exemplary embodiment of the present invention;

FIG. 20 illustrates a structure of a first correction database according to an exemplary embodiment of the present invention; and

FIG. 21 is a block diagram illustrating a system for leading composition according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

The term “leading composition” used hereinafter refers to teaching and learning written composition. The term “leading” used hereinafter refers to teaching and learning. The term “learner” used hereinafter refers to any person learning to compose or write.

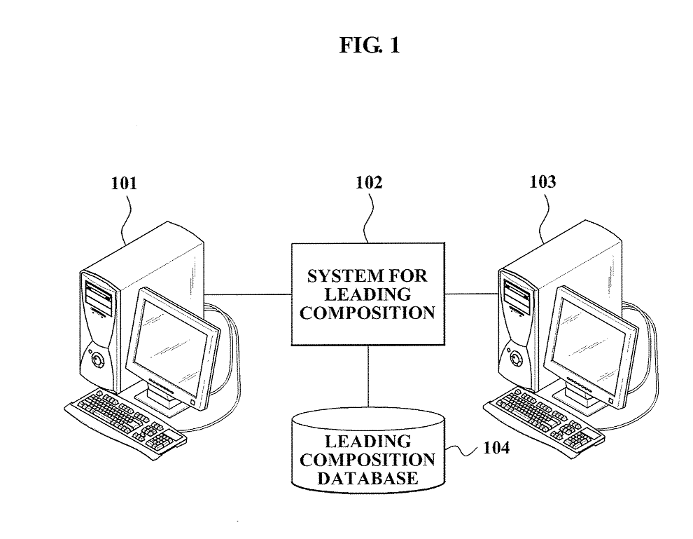

FIG. 1 is a schematic view illustrating a method and system for leading composition according to an exemplary embodiment of the present invention. A learner prepares a first composition and transfers the first composition to a system for leading composition 102 through a learner interface 101b, the leading composition system 102 provides the received first composition to the instructor through an instructor interface 103b, and then the instructor selects or prepares first correction information, correct answer information, second correction information and estimation information by referring to a leading composition database 104 so as to transfer the first correction information, the correct answer information, the second correction information, and the estimation information to the system for leading composition 102. The system for leading composition 102 provides the received first correction information and first index information to the learner through the learner interface 101b by which the learner verifies the first correction information and the first index information. The learner prepares a second composition by modifying the first composition, and transfers the prepared second composition to the system for leading composition 102. Consequently, the system for leading composition 102, after receiving the modified first composition, provides correct answer information, second correction information, second index information and estimation information to the learner in the above order.

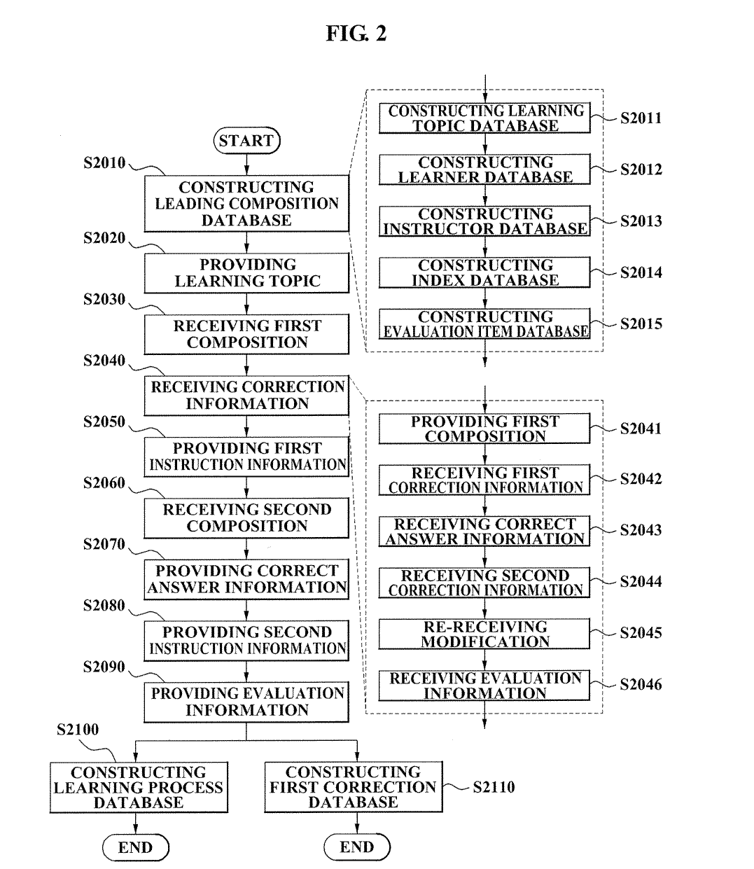

Hereinafter, the method and system for leading composition as described above will be explained in detail with reference to FIGS. 2 to 19.

FIG. 2 is a flowchart illustrating a method for leading composition according to an exemplary embodiment of the present invention.

In step S2010, the system for leading composition 102 organizes information required for leading composition as a leading composition database. In the step of S2010, the system for leading composition is classified into five steps of S2011 through S2015.

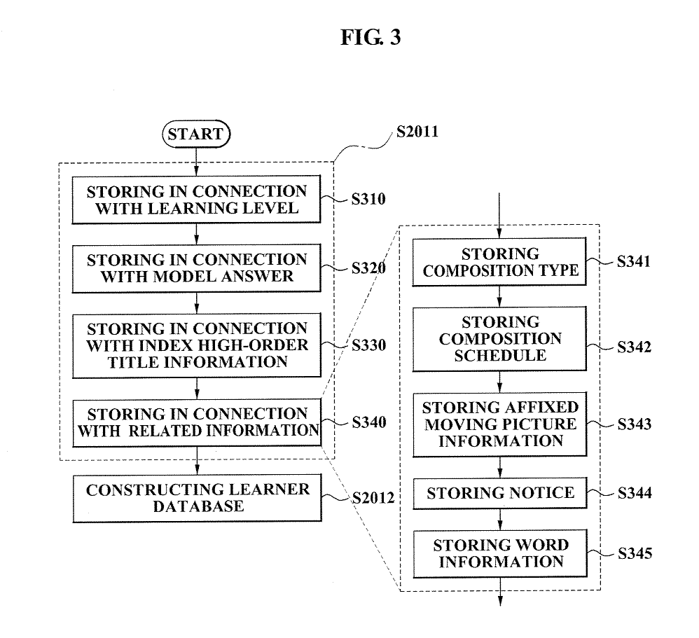

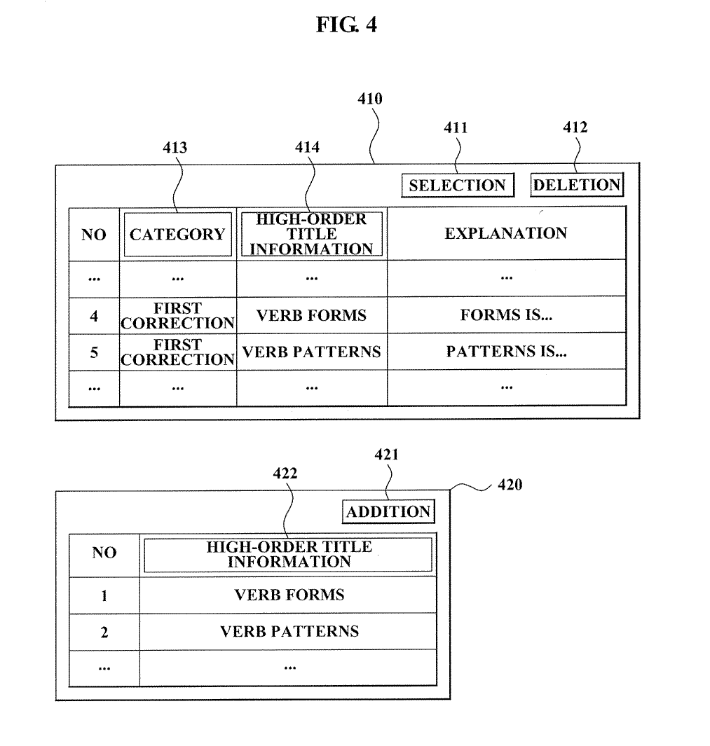

In step S2011, the system for leading composition 102 associates a learning topic with a learning level of a learner to which the learning topic is provided and stores the associated learning topic and the associated learning level. The system 102 further stores a model answer with respect to the learning topic by linking with the learning topic, and further links high-order title information included in the index from a learning information index according to the learning topic by referring to an index database and thereby stores the inter-linked high-order title information and the inter-linked learning topic. In addition, the system for leading composition 102 stores related information including a notice for composition type, composition schedule, affixed moving picture information, correction with respect to the learning topic, and word information in association with the learning topic. Detailed explanations with respect to step S2011 will be provided hereinafter with reference to FIGS. 3 and 4.

In step S2012 of FIG. 2, the system for leading composition 102 constructs a learner database by storing information such as name, ID, password, and learning level of the learner. The system 102 selects, through a certification by referring to the learner database 101a, a correct learner to whom the learning topic is intended to be provided. In step S2013 of FIG. 2, the system 102 organizes the instructor database 103a by receiving name, ID, and password of the instructor providing the leading composition through the instruction interface 103b. The system 102 selects, through a certification by referring to the instructor database 103a, a correct instructor who is intended to transfer instructor information with respect to the first composition prepared by the learner. In addition, the leading composition database 104 organizes a learning process database by referring to the learner database 101a and the instructor database 103a.

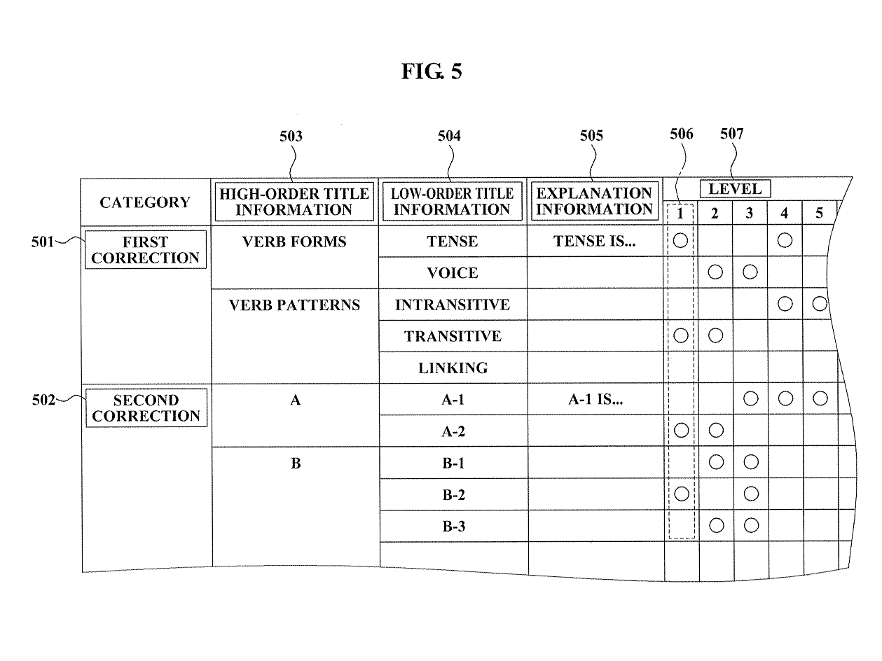

In step S2014 of FIG. 2, the system 102 categorizes the index, and stores the categorized index in association with the learning level of the learner. Detailed explanations with respect to step S2014 will be given hereinafter with reference to FIG. 5. In step S2015 of FIG. 2, the system 102 constructs an estimation item database including information related to grammar, addressing the learning topic, organization, idea, and accuracy. The system 102 allows the instructor to receive estimation information by referring to the estimation item database, and provides estimation information prepared based on estimation items stored in the estimation item database to the learner.

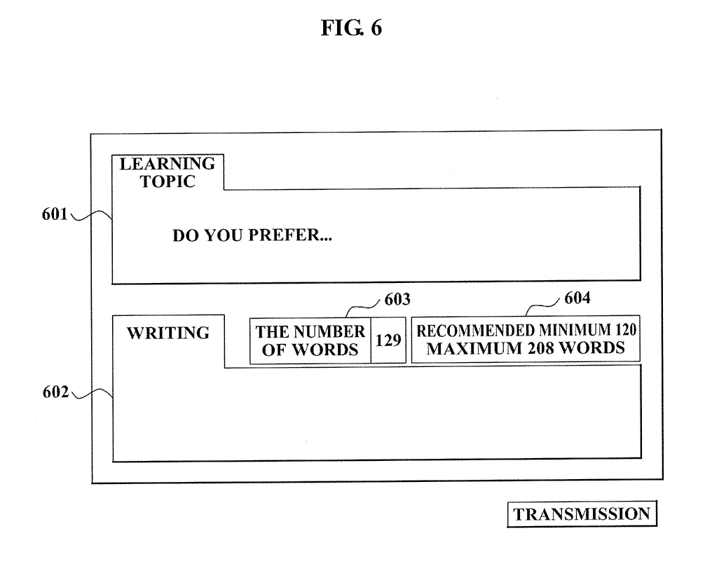

In step S2020 of FIG. 2, the system 102 provides a learning topic to the learner by referring to a learning topic database, and the learning topic is chosen by referring to the learning level, composition type and composition schedule of the learner stored in the learning topic database. Furthermore, the system 102 allows a number of words submitted by the learner to be extracted from the learning topic database to be provided together with the learning topic. In step S2030 of FIG. 2, the system 102 receives first composition prepared by the learner with respect to the provided learning topic from the learner. Detailed explanations with respect to step S2030 will be provided hereinafter with reference to FIG. 6.

In step S2040 of FIG. 2, the system 102 receives correction information from the instructor. The correction information may include first correction information, correct answer information, second correction information and estimation information. In step S2040, the system 102 is further broken down into six steps of S2041 through S2046. In step S2041 of FIG. 2, the system 102 provides first composition received from the learner to the instructor. The received first composition may be modified and returned to the learner depending on the first correction information, correct answer information, second correction information, and estimation information provided from the instructor.

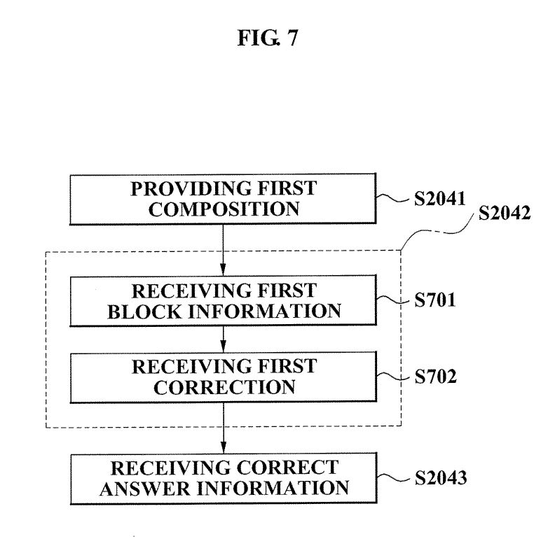

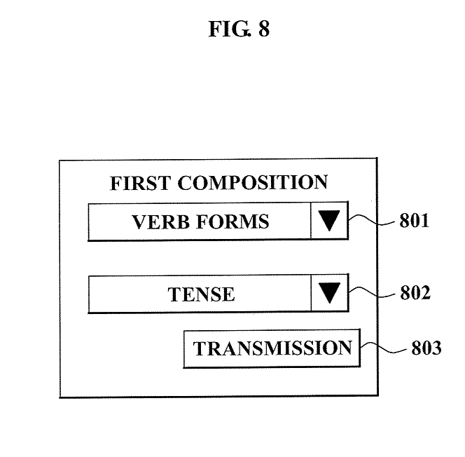

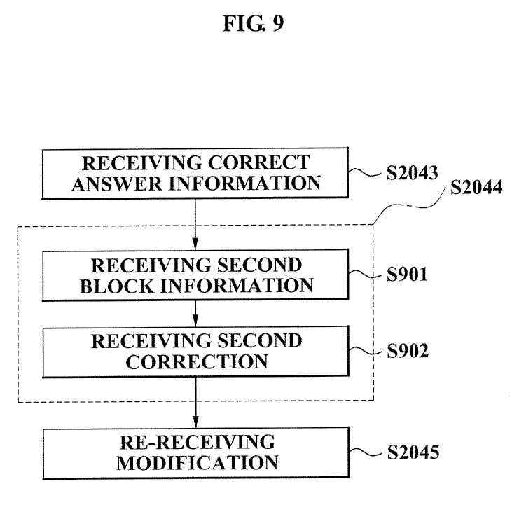

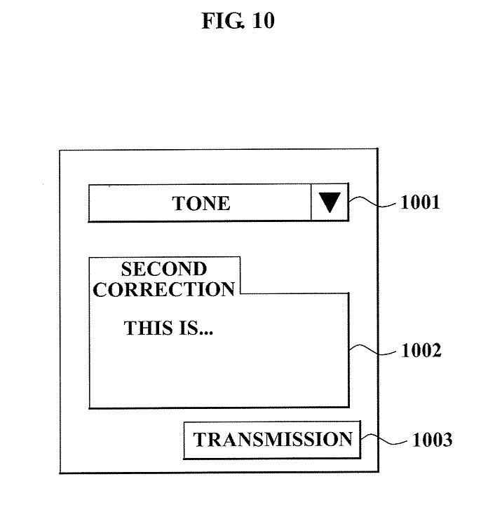

In step S2042 of FIG. 2, the system 102 receives the first correction information from the instructor which includes first block information and the first correction selected with reference to the provided first composition. Detailed explanations with respect to step S2042 will be given hereinafter with reference to FIGS. 7 and 8. In step S2043 of FIG. 2, the system 102 receives correct answer information associated with the first correction information from the instructor. In step S2043, the instructor selects the first correction information, and simultaneously prepares correct answer information corresponding to the first correction information so as to transfer the prepared correct answer information to the system for leading composition 102. In step S2044 of FIG. 2, the system 102 receives second correction information from the instructor. The second correction includes second block information and second correction selected with reference to the first composition provided. Detailed explanations with respect to step S2044 will be provided hereinafter with reference to FIGS. 9 and 10.

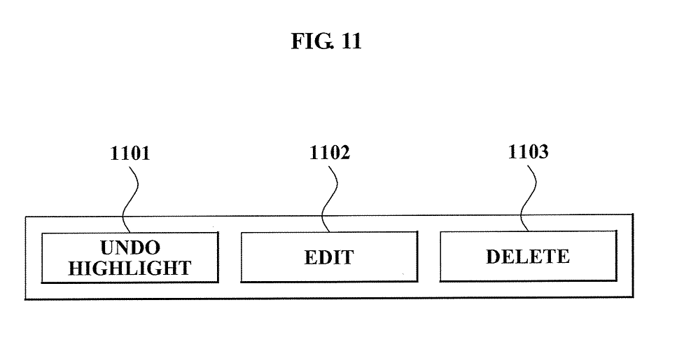

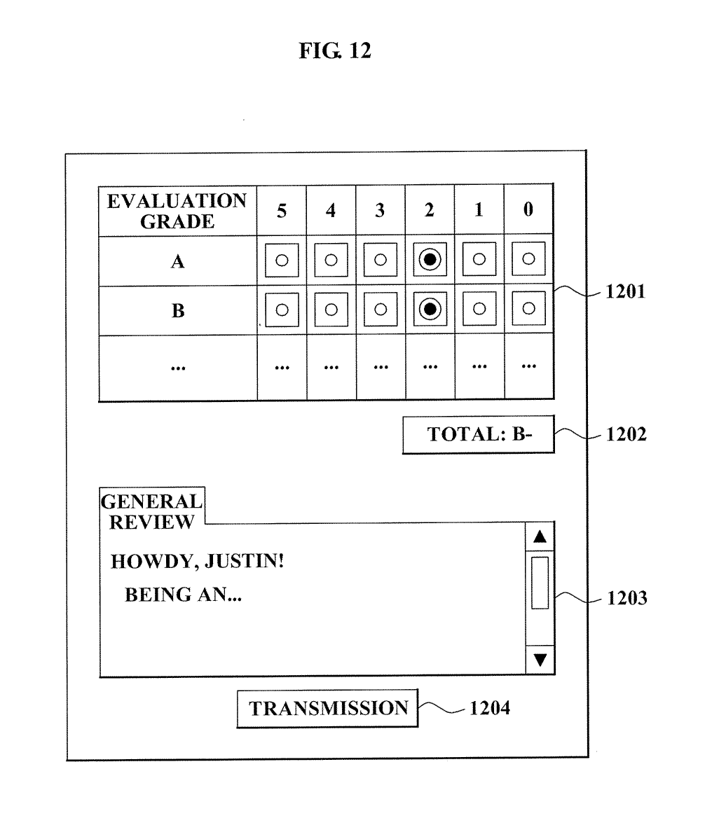

In step S2045 of FIG. 2, the system 102 re-receives from the instructor the first correction information, correct answer information, second correction information, and estimation information which have been modified by the instructor. Detailed explanations with respect to step S2045 will be given hereinafter with reference to FIG. 11. In step S2046 of FIG. 2, the system 102 receives estimation information with respect to the first composition from the instructor. Detailed explanation with respect to step S2046 will be provided hereinafter in FIG. 12.

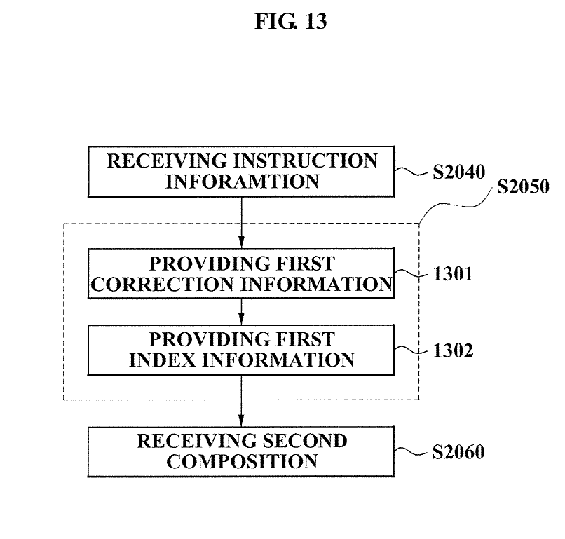

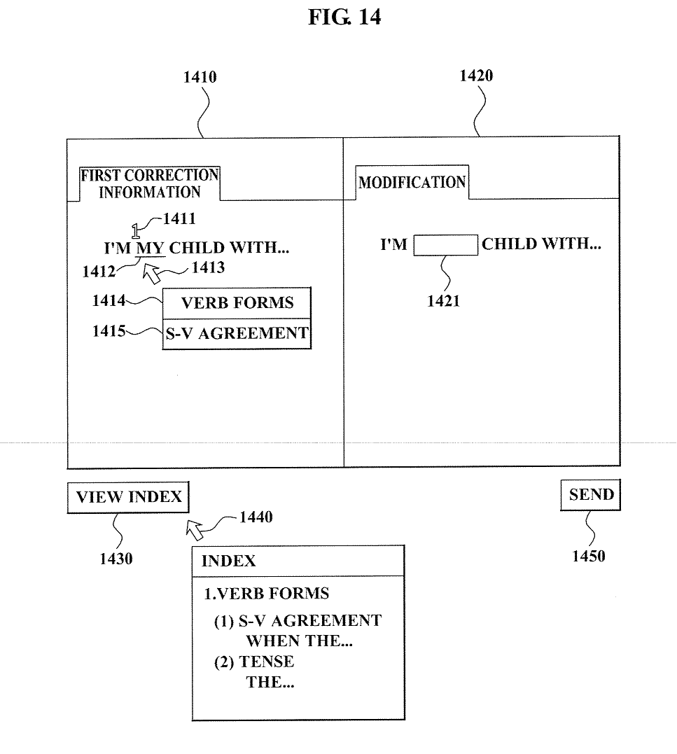

In step S2050 of FIG. 2, the system 102 provides first instructor information to the learner. The first instructor information may include first correction information including the first block information, the first correction, and first index information. The first index information designates index information classified with respect to first correction information from the index information stored in association with the learning level of the learner in the index database. Detailed explanations with respect to step S2050 will be provided hereinafter with reference to FIGS. 13 and 14.

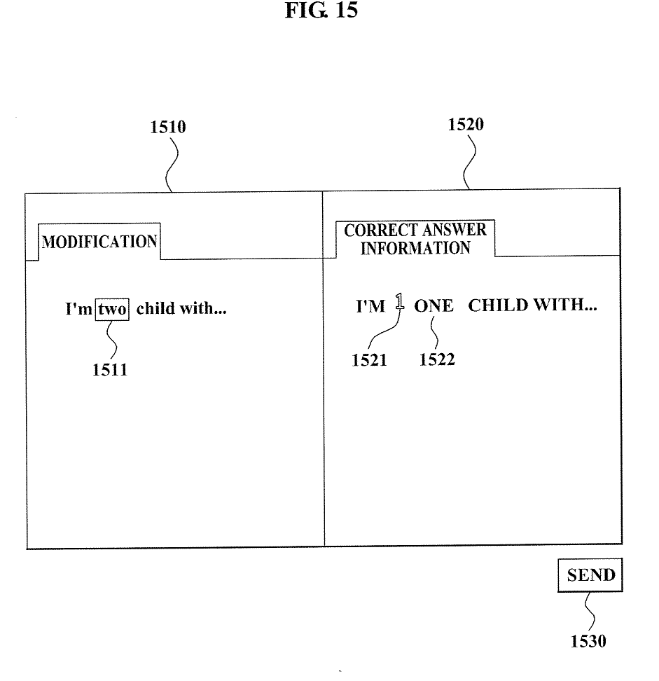

In step S2060 of FIG. 2, the system 102 enables the learner to modify errors corresponding to the first block information provided to the learner. The system 102 then receives second composition reflecting the modification from the learner. According to an exemplary embodiment of the present invention, referring to FIG. 14, the learner enters a new composition in a block portion 1421 set corresponding to the first block information and sends a second composition to the system 102. In step S2070 of FIG. 2, the system 102 provides a correct answer information on the right hand side replacing a block portion from the to the first block information on the left hand side input by the learner for the learner to view the correct answer. Detailed explanations with respect to step S2070 will be provided hereinafter with reference to FIG. 15.

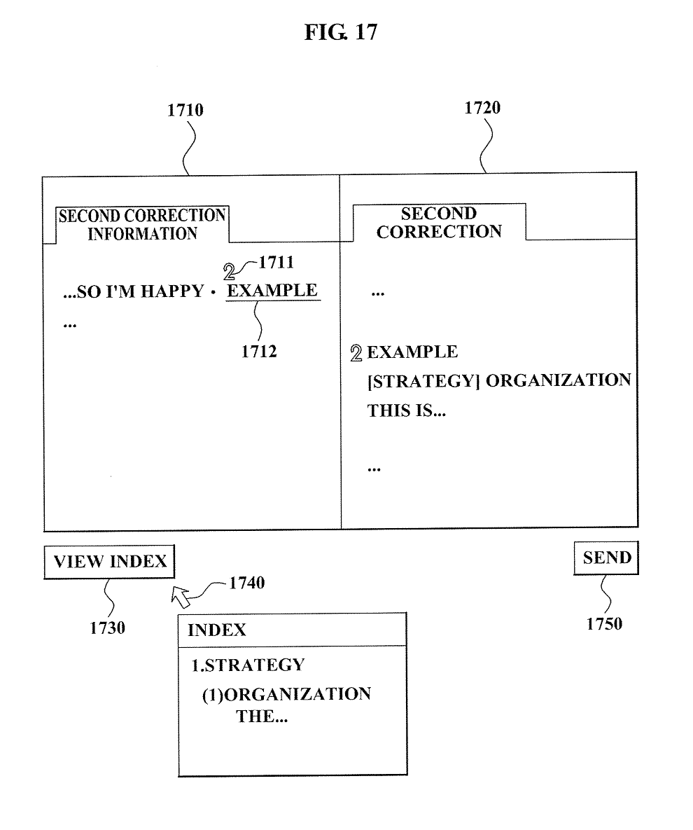

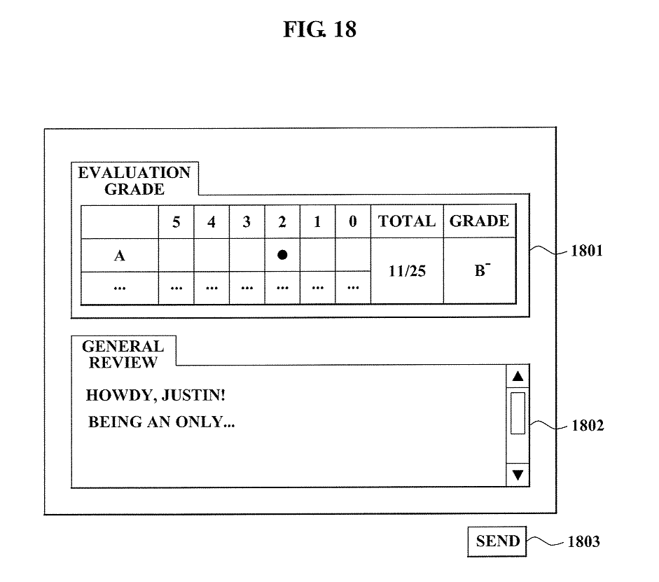

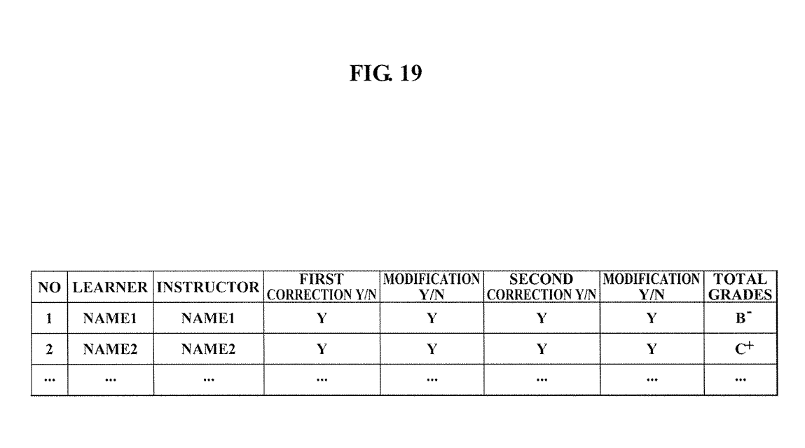

In step S2080 of FIG. 2, the system 102 provides second instruction information to the learner. The second instruction information includes second correction information including second error information, second instruction, and second index information. The second index information designates index information classified with respect to the second correction information from the index information stored in the index database. The index information is associated with the learning level of the learner. Detailed explanations with respect to step S2080 will be provided hereinafter with reference to FIG. 17. In step S2090 of FIG. 2, the system 102 provides evaluation information received from the instructor in step S2046 to the learner. Detailed explanations with respect to step S2090 will be provided hereinafter with reference to FIG. 18. In step S2100 of FIG. 2, the system 102 constructs a learning process database by categorizing and storing a leading process performed by means of the method for leading composition. Detailed explanations with respect to step S2100 will be hereinafter provided with reference to FIG. 19.

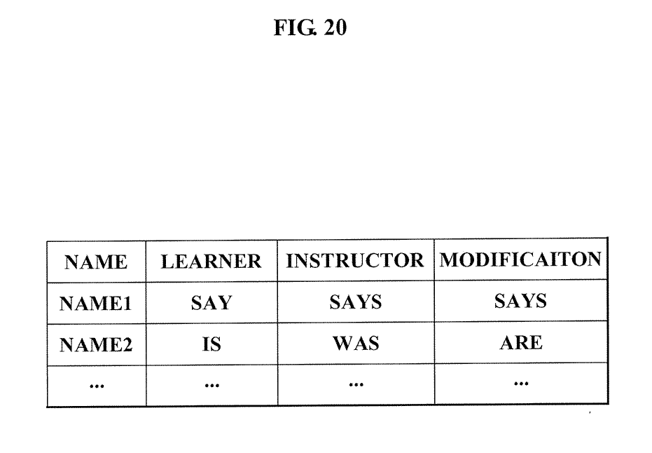

In step S2110 of FIG. 2, the system 102 constructs a first correction database by storing the first correction information. Detailed explanations with respect to step S2110 will be provided hereinafter with reference to FIG. 20.

FIG. 3 is a flowchart illustrating a method for constructing a learning topic database according to an exemplary embodiment of the present invention. In step S2011, the system 102 constructs a learning topic database. In step S2011, the system for leading composition 102 is further classified into five steps of S310 through S340. In step S310 of FIG. 3, the system 102 selects a learning level of a learner to whom the learning topic is provided or a learning process to which the learning topic is provided. The system 102 then stores the selected learning level and the learning process in a learning topic database in association with the learning topic. In step S320 of FIG. 3, the system 102 stores model answers associated with the learning topic in a learning topic database in association with the learning topic to be provided to a learner.

In step S330 of FIG. 3, the system 102 associates the learning topic and high-order title information which is extracted from the index database. The index database is comprised of indexes storing and providing learning information according to the learning topic. The system 102 further stores the associated learning topic and the extracted high-order title information. Detailed explanations with respect to step S330 will be provided hereinafter with reference to FIG. 4.

In step S340 of FIG. 3, the system 102 stores related information associated with the learning topic. In step S340, the system for leading composition 102 is further broken down into five steps of S341 through S345. In step S341, the system 102 selects and stores composition type (i.e., Independent, Project, Prediction, and Academic) associated with the learning topic. In step S342, the system 102 further stores a schedule by which the learning topic is provided to the learner, and correction as well as evaluation are provided to the learner. In step S343, the system 102 stores moving picture information associated with the learning topic. In step S344, the system 102 stores a note which is provided to the instructor for correction associated with the learning topic. In step S345, the system 102 also stores the number of words being allowed to be included in the first composition received from the learner as associated with the learning topic.

FIG. 4 illustrates a process for constructing a learning topic database in association with high-order title information included in an index as an exemplary embodiment of the present invention. The system 102 may include step S330 for storing index information associated with high-order title information. The first and second correction information associated with the learning topic is provided from an instructor so that high-order title information to be selected by the instructor is limited. Since the instructor may only select high-order title information stored in the index database associated with first and second correction, a learner is provided to select from the first correction, second correction or the selected correction with definitive choices using an objective criteria. More particularly, when a correction is not suitable for the learning level of the learner and the instructor wishes to correct other error parts, the instructor is prevented from selecting any parts other than what is provided from the index database constructed by previously crafted corrections. Additionally, if there is a problem with a first correction, the system 102 can be supplemented with a second correction information by preparing a second correction information. The system for leading composition 102 has a selection button 411 displayed in a display 410 for a user to add high-order title information. By selecting the high-order title information 414, the display for high-order title information 420 in which different high-order title information is displayed and arranged, pops up allowing a user to add different high-order title information in the display 420 by clicking on the addition button 421. Furthermore, the system 102 allows for deletion of the selected high-order title information by selecting a certain high-order title information and clicking a deletion button 412. The display 410 for adding high-order title information may include other features such as a category button 413, a high-order title information button 414, and explanations as shown in display 410.

FIG. 5 illustrates a structure of an index database according to an exemplary embodiment of the present invention. The system 102 includes the step of S2014 for constructing an index database. The index database comprises features such as a category, high-order title information 503, low-order title information 504, explanation information 505, and learning level 507. Index information extracted from the index database enables the learner to conduct logical acquisition associated with the learning topic. Since the index database is constructed so as to enable index information provided to the learner to be utilized according to the learning level, the system 102 provides suitable logic to the learner according to the learning level of the learner. For example, in learning level I as shown in FIG. 5, index information for different levels are provided to be selected which are denoted by circles. First correction 501 and second correction 502 are categorized and stored in the index database as illustrated in FIG. 5. In providing first correction information, only the first index information categorized into the first correction and stored is provided to the learner. In providing second correction information, only the second index information categorized into the second correction and stored is provided to the learner.

FIG. 6 illustrates a process for receiving a first composition from a learner according to an exemplary embodiment of the present invention. The learner sees a learning topic 601 with reference to information of a number of words 604 extracted from the learning topic database, prepares the first composition, and transfers the prepared first composition to the system for leading composition 102. The learner transfers the prepared first composition to the system 102 by clicking on the transmission button once the learner is ready to send the first composition.

FIG. 7 is a flowchart illustrating a process for receiving the first correction information from an instructor according to an exemplary embodiment of the present invention. Step S2042 for receiving first correction information includes step S701 for receiving first block information, and step S702 for receiving first correction. In step S701, the system 102 receives first block information from an instructor to whom the first composition is provided. The first block information designates block parts set by the instructor when the instructor searches for grammatical errors existing in the first composition prepared by the learner, positions his or her mouse cursor in the parts with grammatical errors, and drags the mouse cursor to those parts. In step S702, the system 102 receives first correction corresponding to the parts viewed by the instructor through the first block information. According to an exemplary embodiment of the present invention, the first block information and first correction are connected to each other. The first block information and first correction are stored either through a method by which the first block information is set by dragging a mouse point to the block portion and the right button of the mouse is clicked or by clicking the separate addition button of the first correction.

FIG. 8 illustrates a process for receiving a first correction from an instructor according to an exemplary embodiment of the present invention. First correction may be selected only through the high-order title information stored in association with high-order learning topic as previously shown in step 330 of FIG. 3. The first correction is stored in association with index high-order title information as shown in the previous step S2011 in FIG. 3 for constructing a learning topic database. The above described technical feature is to maintain objectivity and definitive rules for leading composition. The system 102 allows selection of high-order title information extracted from the learning topic database when a verb forms button 801 is selected. The system 102 further allows extraction of low-order title information additionally stored which is associated with the high-order title information from the index database when the extracted low-order title information is selected by clicking on a tense button 802. First correction is not prepared and input by an instructor, but rather is selected from the high-order and low-order title information previously defined in the system 102.

FIG. 9 is a flowchart illustrating a process for receiving second correction information from an instructor according to an exemplary embodiment of the present invention. Step S2044 for FIG. 9 demonstrates receiving second correction information which is further broken down into two steps of S901 for receiving second block information and S902 for receiving the first correction. In step S901, the system 102 receives second block information from an instructor to whom the first composition is provided. The second block information designates the block parts set for the instructor when the instructor searches for strategy errors, substance errors, and style errors existing in the first composition prepared by the learner. The instructor can position a mouse to point to the part containing errors and drags the mouse point to those parts. The errors are exemplary and may include other error types occurring in the process for preparing compositions. In step S902, the system 102 receives second correction corresponding to the parts viewed by the instructor through the second block information. According to an exemplary embodiment of the present invention, the second block information and second correction are connected to each other. The second block information and second correction are stored either through a method by which the second block information is set by dragging a mouse point to the block portion and then a right button of the mouse is clicked, or by clicking the separate addition button of the second correction.

FIG. 10 illustrates a process for receiving second correction from an instructor according to an exemplary embodiment of the present invention. Second correction may be selected only through high-order title information stored in association with high-order learning topic as shown in step S330 of FIG. 3. Second corrections are stored in connection with index high-order title information as previously shown in step S2011 for constructing a learning topic database. The technical feature as described above is to maintain objectivity and definitive rules in leading composition. The system 102 allows for selection of high-order title information extracted from the learning topic database by clicking on a tone button 1001. By clicking on the tone button 1001, an instructor can select high-order title information. An instructor can additionally input 1002 a second correction associated with the high-order title information, and the system 102 receives the input correction from the instructor when the instructor transmits the second correction to the system by clicking on the transmission button 1003. An instructor can, therefore, input correction and make a second correction through the system 102. As a result, inefficiency of leading composition created by uniform correction using objective correction in the system is significantly reduced.

FIG. 11 illustrates a process for re-receiving instruction information which is modified by an instructor according to an exemplary embodiment of the present invention. The instructor modifies the first and second correction information through the step of S2045, as previously shown in FIG. 9, for re-receiving correction. By using and clicking on a Undo Highlight button 1101 for modifying the first block information and second block information, an Edit button 1102 for modifying first correction and second correction, and a Delete button 1103 for deleting first correction information and second correction information, the instructor can re-transfer the modified first and second correction information to the system 102.

FIG. 12 illustrates a process for receiving estimation information from an instructor according to an exemplary embodiment of the present invention. In step S2046 of FIG. 2 for providing evaluation information, the individual grades 1201 associated with evaluation items extracted from an evaluation item database previously constructed by the instructor are selected, a general review is prepared 1203, and the general review is prepared by the system. The system calculates and generates the total grades to provide all the grades to the instructor for review.

FIG. 13 is a flowchart illustrating a process for providing first instruction information to a learner according to an exemplary embodiment of the present invention, and FIG. 14 illustrates a process for providing second instruction information to a learner according to an exemplary embodiment of the present invention.

Step S2050 for providing first instruction information includes steps of 1301 for providing first correction information and 1302 for providing first index information. In step 1301, the system 102 provides first correction information including the first block information and first correction to a learner after a learner submits the first composition. As illustrated in FIG. 14, the learner sees the first block information 1411 which was selected and transferred to the system 102 by the instructor. In FIG. 14, the learner also sees high-order title information 1414 such as Verb Forms and low-order title information 1415 such as S-V Agreement included in the first correction when the learner moves the mouse cursor point 1413 to the position of first block information 1412.

In step 1302 of FIG. 13, the system 102 provides index information extracted from the index database to the learner. The index database previously defined and constructed classifies index information according to the learning level of the learner. The system 102 only provides index information according to the learning level of the learner. The index information includes information such as category, high-order title information, low-order title information and explanation stored in the index database in association with the learning level of the learner. Specifically, in the step of 1302, only the first index information classified into first correction and stored is extracted from the index database. As illustrated in FIG. 14, the learner sees the index information by positioning the learner's mouse cursor to a view index button 1430 for viewing index information extracted by the system 102. The first index information includes only first index information corresponding to the first correction information.

FIG. 15 illustrates a process for providing correct answer information to a learner according to an exemplary embodiment of the present invention. In step S2070 of FIG. 2 for providing a correct answer, the system 102 provides correct answer information to the learner corresponding to the first correction information. A left display 1510 of FIG. 15 shows a second composition newly prepared with reference to the first correction information and first index information which are transferred to the system 102 by the learner. The right display 1520 shows the correct answer information 1522 received from the instructor as illustrated in step S2040.

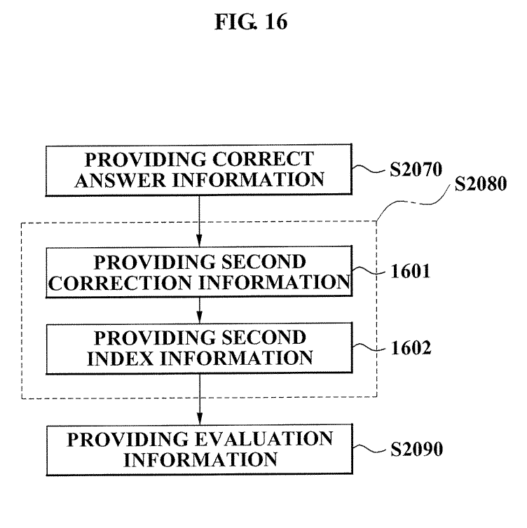

FIG. 16 is a flowchart illustrating a process for providing a second correction information to a learner according to an exemplary embodiment of the present invention, and FIG. 17 illustrates a process for providing second correction information to a learner according to an exemplary embodiment of the present invention.

Step S2080 of FIG. 16 illustrates providing a second instruction information which includes steps 1601 for providing a second correction information and 1602 for providing a second index information. In step 1601, the system 102 provides second correction information including the second block information and second correction to the learner after the learner submitted the first composition. As shown in FIG. 17, the second block information 1711 can be selected and transferred to the system 102 by the instructor. The second correction display on the right 1720 can be viewed and provided to the learner through the system 102.

In step 1602, the system 102 provides index information extracted from the index database to the learner. The index database previously constructed classifies index information according to the learning level of the learner, and the system only provides index information according to the learning level of the learner. The index information includes classifications such as category, high-order title information, low-order title information, and explanation stored in the index database associated with the learning level of the learner. Specifically, in step 1302 of FIG. 13, only the second index information classified into second correction and stored is extracted from the index database. As illustrated in FIG. 17, the learner sees the index information by positioning and clicking the learner's mouse cursor 1740 on a view index button 1730 for viewing the index information extracted by the system 102. The index information only includes information corresponding to the second correction information.

FIG. 18 illustrates a process for providing estimation information to a learner according to an exemplary embodiment of the present invention. In step S2090 of FIG. 2 for providing evaluation information, the system 102 generates and provides evaluation information to the learner after the first composition is submitted and transferred by the learner. The evaluation information provided to the learner includes an evaluation grade 1801 and a general view 1802. The evaluation grade 1801 further includes evaluation items, grades based on the evaluation items and total grade information.

FIG. 19 illustrates a structure of a learning process database according to an exemplary embodiment of the present invention. In step S2100 of FIG. 2, the system 102 constructs a learning process database based on information about a learner, an instructor, information as to whether a first correction exists, whether a modification is made, a second correction, an evaluation, and a total grade. The learning process database is provided both to the learner and the instructor so that it is used to compile data for determining the process of applying the method for leading composition. The configurational component as described above is provided only as an example and may be re-constructed by including other additional components.

FIG. 20 illustrates a structure of a first correction database according to an exemplary embodiment of the present invention. In step S2110 of FIG. 2, the system 102 constructs a first correction database comprising the name of a learner, first composition of a learner, correct answer information of an instructor, and modification information made by the learner. The first correction database is provided both to a learner and an instructor and used as an effective information data of applying the present invention of leading composition. The configurational component as described above is provided only as an example and may be re-constructed by including other additional components.

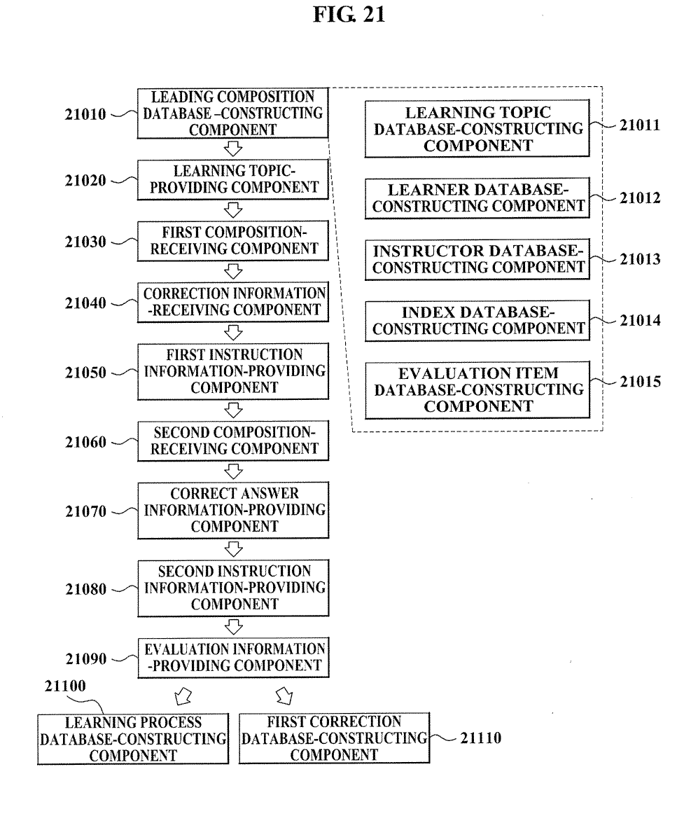

FIG. 21 is a block diagram illustrating a system for leading composition 102 according to an exemplary embodiment of the present invention. As shown in FIG. 21, the system for leading composition 102 comprises a leading composition database-constructing component 21010, a learning topic-providing component 21020, a first composition-receiving component 21030, a correction information-receiving component 21040, a first instruction information-providing component 21050, a second composition-receiving component 21060, a correct answer information-providing component 21070, a second instruction information-providing component 21080, an evaluation information-providing component 21090, a learning process database-constructing component 21100, and a first correction database constructing component 21110.

The leading composition database-constructing component 21010 stores learning topics, information regarding a learner, information regarding an instructor, learning information, and evaluation information so as to construct a leading composition database. The leading composition database-constructing component 21010 comprises a learning topic database-constructing component 21011, a learner database-constructing component 21012, an instructor database-constructing component 21013, an index database-constructing component 21014, and an evaluation item database-constructing component 21015.

The learning topic database-constructing component 21011 stores different learning topics to be provided to the learner so as to construct a learning topic database. The learner database-constructing component 21012 stores learner information including the learning level of the learner so as to construct a learner database. The instructor database-constructing component 21013 stores instructor information with respect to the learning topics so as to construct an instructor database. The index database-constructing component 21014 stores an index being learning information provided to the learner so as to construct an index database. The evaluation item database-constructing component 21015 stores the evaluation items so as to construct an evaluation item database.

The learning topic-providing component 21020 provides the learning topic to the learner with reference to the leading composition database 21010. The first composition-receiving component 21030 receives first composition prepared and submitted by the learner with respect to a certain provided learning topic. The correction information-receiving component 21040 provides the first composition received from the learner to an instructor, and then receives correction information for the first composition from the instructor. The first instruction information-providing component 21050 provides first instruction information to the learner after the learner transferred the first composition to the system 102 and the instructor transferred correction information for the first composition to the system 102. The second composition-receiving component 21060 receives the second composition from the learner to whom the first correction information is provided.

The correct answer information-providing component 21070 provides correct answer information to the learner after the learner submitted and transferred the second composition to the system 102. The second instruction information-providing component 21080 transfers the second instruction information to the learner once the learner transferred the second composition to the system 102. The evaluation information-providing component 21090 provides evaluation information to the learner to whom the second correction information is also provided. The learning process database-constructing component 21100 categorizes and stores a process of leading composition as applied by the previous steps of the invention so as to construct a learning process database. The first correction database-constructing component 21110 stores the first correction so as to construct a first correction database.

The method and system for leading composition according to the above-described exemplary embodiments of the present invention may be recorded in computer-readable media including program instructions to implement various operations embodied by a computer. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. The computer-readable recording medium can also be distributed over network-coupled computer systems so that the computer-readable code is stored and executed in a distributed fashion. Examples of program instructions include both machine code, such as produced by a compiler, and files containing higher level code that may be executed by the computer using an interpreter. Also, functional programs, codes, and code segments for accomplishing the present invention can be easily construed as within the scope of the invention by programmers skilled in the art to which the present invention pertains. The described hardware devices may be configured to act as one or more software modules in order to perform the operations of the above-described exemplary embodiments of the present invention.

As described above, according to the method and system for leading composition of the present invention, the ability to effectively communicate based on appropriate grammar application integrated with writing is improved, so that the ability to compose can be improved. Instructors can concentrate on several items and carry out repeatable correction means by applying an objective criteria based on index data which is collected and analyzed from general errors made by learners according to individual composition levels. Correcting composition errors by teaching and learning does not depend on the subjective knowledge and grading of an instructor and subjective feedback from instructors can be prevented. A learner can figure out which part of the composition needs work and have an opportunity to modify errors independently by using the present invention. The learner can figure out what or how to modify a composition by the use of the present invention for the learning person to effectively improve the ability to compose, communicate and write effectively.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method for leading composition, the method comprising:
constructing a leading composition database including an index database in which index information associated with the composition is stored;
providing a learning topic to a learner with reference to the leading composition database and receiving correction information associated with the composition prepared by the learner from an instructor;
extracting the index information from the index database included in the leading composition database; and
providing instruction information including the correction information and the index information to the learner.

2. The method of claim 1, wherein the method of constructing the leading composition database includes:
constructing the index database by storing the index information being leading information provided to the learner;
constructing a learning topic database by storing the learning topic provided to the learner;
constructing a learner database by storing learning information including a learning level of the learner;
constructing an instructor database by storing instructor information associated with the learning topic; and
constructing an evaluation items database by storing evaluation items related to the learning topic.

3. The method of claim 2, wherein the method of constructing the learning topic database includes:
storing the learning topic in association with the learning level of the learner being provided with the learning topic;
storing a model answer associated with the learning topic related to the learning level of the learner; and
extracting high-order title information from the index database and storing the extracted high-order title information in association with the learning topic.

4. The method of claim 3, wherein the method of constructing the learning topic database further includes:
storing related information including a notice for composition type, composition schedule, affixed moving picture information, correction associated with the learning topic, and word information associated with the learning topic.

5. The method of claim 2, wherein the method of constructing the index database includes:
categorizing the index information and storing the categorized index information in association with the learning level of the learner.

6. The method of claim 1, wherein the method of providing the learning topic to the learner with reference to the leading composition database and receiving instruction information associated with the composition prepared by the learner from the instructor further includes:
providing the learning topic to the learner with reference to the leading composition database;
receiving first composition prepared by the learner associated with the learning topic from the learner; and
receiving correction information associated with the first composition from the instructor after providing the first composition to the instructor.

7. The method of claim 6, wherein the method of receiving correction information associated with the first composition from the instructor after providing the first composition to the instructor includes:
providing the first composition to the instructor;
receiving first correction information associated with the first composition from the instructor;
receiving correct answer information associated with the first correction information from the instructor;
receiving second correction information from the instructor; and
receiving evaluation information including an evaluation result and a general review associated with the first composition from the instructor.

8. The method of claim 6, wherein the method of receiving correction information associated with the first composition from the instructor after providing the first composition to the instructor further includes:
re-receiving the first correction information, the correct answer information, and the second correction information from the instructor after the first correction information, the correct answer information and the second correction information are modified by the instructor.

9. The method of claim 7, wherein the method of receiving first correction information includes:
receiving first block information showing error parts associated with the first composition from the instructor;
extracting high-order title information stored in association with the learning topic from the learning topic database, and receiving first correction selected from the high-order title information in association with the first block information from the instructor; and
extracting low-order title information stored in association with the high-order title information from the index database, adding low-order title information selected from the extracted low-order title information to the first correction, and receiving the added low-order title information from the instructor.

10. The method of claim 7, wherein the receiving second correction information includes:
receiving second block information viewing error parts associated with the first composition from the instructor;
extracting high-order title information stored in association with the learning topic from the learning topic database, and receiving from the instructor second correction selected from the extracted high-order title information in association with the second block information; and
adding detailed correction directly input by the instructor to the second correction and receiving the added detailed correction from the instructor.

11. The method of claim 1, wherein the extracting the index information from the index database includes:
extracting first index information in association with the learning level of the learner from the index information categorized into first correction information from the index database; and
extracting second index information in association with the learning level of the learner from the index information categorized into second correction information from the index database.

12. The method of claim 1, wherein the method of providing the instruction information to the learner includes:
providing first instruction information to the learner;
receiving second composition from the learner;
providing correct answer information to the learner;
providing second instruction information to the learner; and
providing evaluation information to the learner.

13. The method of claim 12, wherein the method of providing the first instruction information to the learner comprises providing the learner with first correction information from the instructor and further providing the learner with first index information extracted from the index database.

14. The method of claim 12, wherein the method of receiving the second composition from the learner comprises enabling the learner to independently modify errors displayed in a part corresponding to first block information from the first instruction information and receiving the second composition reflecting the modification from the learner.

15. The method of claim 12, wherein the method of providing the second instruction information to the learner comprises providing the second correction information received from the instructor to the learner and further providing the learner with second index information extracted from the index database.

16. The method of claim 12, wherein the method of providing evaluation information to the learner by providing the evaluation information including an evaluation grade and a general review provided from the instructor to the learner.

17. The method of claim 1, further comprising:
constructing a learning process database by categorizing and storing a leading process performed by the method for leading composition.

18. A system for leading composition, the system comprising:
a leading composition database-constructing component configured to construct a leading composition database by storing leading composition information including an index associated with the composition;
a learning topic-providing component configured to provide a learning topic to a learner with reference to the leading composition database;
a first composition-receiving component configured to receive first composition prepared associated with the learning topic from the learner;
a correction information-receiving component configured to receive correction information associated with the first composition from an instructor after providing the first composition to the instructor;
a first instruction information-providing component configured to provide first instruction information to the learner;
a second composition-receiving component configured to receive second composition from the learner;
a correct answer information-providing component configured to provide correct answer information to the learner;
a second instruction information-providing component configured to provide second instruction information to the learner; and
an evaluation information-providing component configured to provide evaluation information to the learner.

19. The system of claim 18, wherein the leading composition database-constructing component includes:
a learning topic database-constructing component configured to construct a learning topic database by storing a learning topic to be provided to the learner;
a learner database-constructing component configured to construct a learner database by storing learner information including a learning level of the learner;
an instructor database-constructing component configured to construct an instructor database by storing instructor information associated with the learning topic;
an index database-constructing component configured to construct an index database by storing an index being learning information provided to the learner; and
an evaluation item database-constructing component configured to construct an evaluation item database by storing the evaluation item.

20. The system of claim 18, further comprising:
a learning process database-constructing component configured to construct a learning process database by categorizing and storing a learning process performed by the system for leading composition.

21. The system of claim 18, further comprising:
a first correction database-constructing component configured to construct a first correction database by categorizing and storing the first correction information.
